(19) United States
(12) Patent Application Publication
(10) Pub. No.: US 2016/0224252 A1
(43) Pub. Date: Aug. 4, 2016

(54) HYBRID MEMORY ARCHITECTURE

(71) Applicant: Intel Corporation, Santa Clara, CA (US)

(72) Inventors: Steven R. Hutsell, Tigard, OR (US); Rajat Agarwal, Beaverton, OR (US); Avinash Sodani, Portland, OR (US); Darrell S. McGinnis, Cornelius, OR (US)

(21) Appl. No.: 14/609,904

(22) Filed: Jan. 30, 2015

(51) Int. Cl. G06F 3/06; G06F 12/08

(52) U.S. Cl. CPC G06F 3/068; G06F 12/0802; G06F 3/0611; G06F 3/0646; G06F 2212/225

(57) ABSTRACT

Hybrid memory architecture technologies are described. In accordance with embodiments disclosed herein, there is provided a processing device having a core and a memory controller communicably coupled to the core to receive a request to fetch data. The memory controller is communicably coupled to a hybrid memory architecture including a near memory, wherein the near memory is divided into a flat memory region and a cache memory region.

### TECHNICAL FIELD

Embodiments described herein generally relate to processing devices and, more specifically, relate to hybrid memory architectures and operating the same.

### BACKGROUND

In computing, memory sub-system components contribute significantly to the performance characteristics of an application. In a memory architecture, systems include both a near memory and a far memory. The near memory typically is lower latency, higher peak bandwidth and lower power per bandwidth than the far memory. Historically, the near memory is used either as a cache or as a flat physical memory and the far memory is used as the physical memory.

### BRIEF DESCRIPTION OF THE DRAWINGS

FIG. 1 is a block diagram of one embodiment of a computing system that implements a memory controller for a hybrid memory architecture according to one embodiment;

FIG. 2 is a block diagram of a core request flow managed by the memory controller for the hybrid memory architecture according to an embodiment of the disclosure;

FIG. 3 is a block diagram of a core request flow managed by the memory controller for the hybrid memory architecture according to an embodiment of the disclosure;

FIG. 4 is a flow diagram illustrating a method for core request flow according to an embodiment of the disclosure;

FIG. 5 is a flow diagram illustrating a method for core request flow according to an embodiment of the disclosure;

FIG. 6A is a block diagram illustrating an exemplary in order pipeline and an exemplary register renaming, out-of-order issue/execution pipeline in accordance with described embodiments;

FIG. 6B is a block diagram illustrating both an exemplary embodiment of an in-order architecture core and an exemplary register renaming, out-of-order issue/execution architecture core to be included in a processor in accordance with described embodiments;

FIG. 7 is a block diagram illustrating a processor according to one embodiment;

FIG. 8 illustrates a block diagram of a computer system according to one embodiment;

FIG. 9 is a block diagram of a system on chip (SoC) in accordance with an embodiment of the present disclosure;

FIG. 10 is a block diagram of an embodiment of a system on-chip (SOC) design.

FIG. 11 illustrates a block diagram of a computer system according to one embodiment.

FIG. 12 illustrates a block diagram of a computer system according to one embodiment.

FIG. 13 illustrates block diagram of an embodiment of tablet computing device, a smartphone, or other mobile device in which touchscreen interface connectors are used; and

FIG. 14 illustrates a diagrammatic representation of a machine in the example form of a computer system within which a set of instructions, for causing the machine to perform any one or more of the methodologies discussed herein, may be executed.

### BRIEF DESCRIPTION OF THE DRAWINGS

Disclosed herein are embodiments for providing a hybrid memory architecture such that a high-bandwidth (near) memory is concurrently divided into a flat region and a cache region.

Existing systems include memory architectures having a high-bandwidth (near) memory, which is used as a either a cache or a flat physical memory. A flat physical memory is a single, continuous address space. A cache memory is a random access memory (RAM) that a computer microprocessor can access more quickly than the regular RAM and generally, holds frequently used data. Generally, in these systems, applications are not optimized enough to handle these two different types of memories with different characteristics, and thus are only able to use the high-bandwidth memory as a cache. As such, applications need to be optimized to use high-bandwidth memory as a flat physical memory. However, even when the applications are optimized, their memory capacity is typically limited due to the lower capacity nature of high-bandwidth memory.

Embodiments of the disclosure overcome the above problems by implementing a hybrid memory architecture using the high-bandwidth (near) memory as both the cache and the flat physical memory. In one embodiment, the high-bandwidth (near) memory is divided into a flat memory region and a cache memory region such that some portion of the memory is accessed as a flat (generic) memory and other portion of the memory is accessed as a memory-side cache (cache). Accordingly, embodiments of the disclosure allow both un-optimized and optimized applications to take advantage of both flat high-bandwidth memory and the cache to maximize performance.

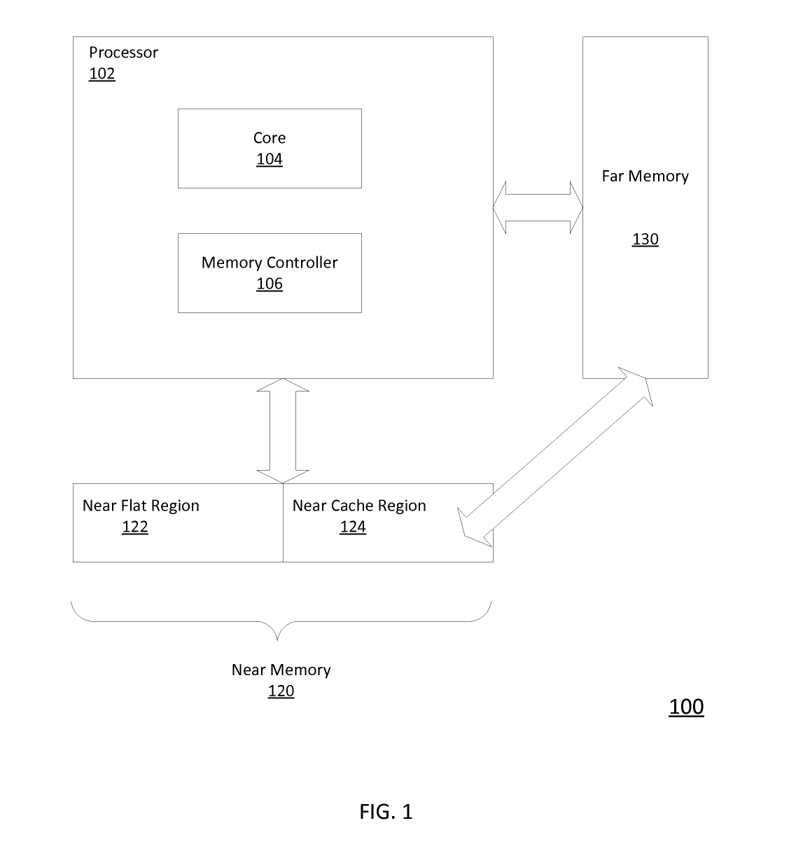

FIG. 1 illustrates a computing system 100 that implements a memory controller 106 for a hybrid memory architecture according to an embodiment of the present disclosure. Some examples of computing system 100 may include, but are not limited to computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. In an embodiment, the computing system may be a system-on-a-chip hardware circuit block that may be implemented on a single die (a same substrate) and within a single semiconductor package.

Referring to FIG. 1, computing system 100 may include a processor 102 that implements at least one core 104 coupled to a memory controller (MC) 106. The core 104 may also be logical processors, which may be considered the processor cores themselves or threads executing on the processor cores. A thread of execution is the smallest sequence of programmed instructions that can be managed independently. Multiple threads can exist within the same process and share resources such as memory, while different processes usually do not share these resources. In one embodiment, the core 104 includes functional units such as CPU, GPU, modem, audio DSP, camera or other devices.

In one embodiment, the MC 106 is coupled to a hybrid memory architecture including a near memory 120 and a far memory 130. In one embodiment, the near memory 120 typically provides lower latency, higher peak bandwidth, and lower power per bandwidth than the far memory 130. In one embodiment, the far memory 130 typically provides higher latency, lower peak bandwidth, and higher power per bandwidth than the near memory 120.

In one embodiment, the near memory 120 is divided into a near flat (NF) region 122 and a near cache region (NC) 124. In one embodiment, the near memory 120 is divided equally into the NF region 122 and the NC region 124. In another embodiment, the near memory 120 is divided unequally into the NF region 122 and the NC region 124. For example, the NF region may take up ¾ of the memory space of the near memory 120 and the NC region may take up ¼ of the memory space of the near memory 120 or vice versa. In one embodiment, a user decides how to divide the near memory 120 between the NF region 122 and the NC region 124. In one embodiment, the user determines at boot-time, prior to operating system (OS) coming online, as to how much of the near memory 120 is to be assigned to the NF region 122 and the rest is assigned to the NC region 124. The OS has the option to limit how much near-flat memory is exposed to applications since it owns the address table and memory allocation functions. But at the hardware level, once it is set (½ cache, ¼ cache, etc), it cannot be changed without a reset/reboot. In one embodiment, requirements of the application may include at least one of a bandwidth, a latency, or a power requirement, or any combination thereof of the core 104.

For example, if the three fourths of the applications are configured to utilize data from the flat memory, then the user may divide the near memory 120 such that the ¾ of the memory space of the near memory 120 is assigned with the NF region 122 and ¼ of the memory space of the near memory 120 is assigned with the NC region 124. In one embodiment, the user assigns the entire near memory 120 as a cache (e.g., NC region 124). The user communicates to the MC 106 information detailing the assignment of the near memory 120. The MC 106 then uses this information to allocate addresses in a system address map to the NF region 122 and the NC region of the near memory 120. In one embodiment, the user configures the MC 106 during boot of the system so that the MC 106 decides, during run time, which portion of the memory addresses are assigned to the NF region 122 and which portion of the memory addresses are assigned to the NC region 124. In one embodiment, the NC region 124 is coupled to the far memory 130. In one embodiment, the far memory 130 is a cache.

In one embodiment, the MC 106 manages the hybrid memory architecture including the near memory 120 and the far memory 130. In one embodiment, the MC 106 is a digital circuit, which manages the flow of data to and from the near memory 120 and to and from the far memory 130. As an example, the MC 106 is a memory address decoder. During runtime, the MC 106 receives requests from the core 104. In one embodiment, the request is to fetch data for the application. The request itself may include whether it is destined for the NF region 122 or the NC region 124 of the near memory 120. In one embodiment, the destination of the request is based on requirements of the application to be executed by the core 104. As discussed above, such requirements may include, but are not limited to, at least one of a bandwidth, a latency, or a power requirement, or any combination of the core 104. The MC 106 maps the request to one of the NF region 120 or the NC region 130 of the near memory 120 based on the destination in the request. In another embodiment, the request does not include the destination. The MC 106 maps the request to one of the NF 120 or the NC 130 of the near memory 120 based on a system address map encoded in the MC 106. During boot, the system is configured into the hybrid configuration requested by the administrator and thus creates a system address map that has distinct near flat and far memory regions. In this mode, these two memory spaces are also considered non-uniform memory access (NUMA) memory nodes and they are listed in advanced configuration and power interface (ACPI) tables, which the OS later references when performing memory management and allocation. The NF region 122 of memory exists as a separate NUMA space. When applications request memory from the OS, they can specify through specialized NUMA function calls to allocate memory in the NF NUMA memory space. The OS then attempts to grant this request. This also means that far memory 130 (which uses the rest of near memory as a cache) is also a separate NUMA memory node. Applications that don't use NUMA functions likely default to using far-memory 130 space.

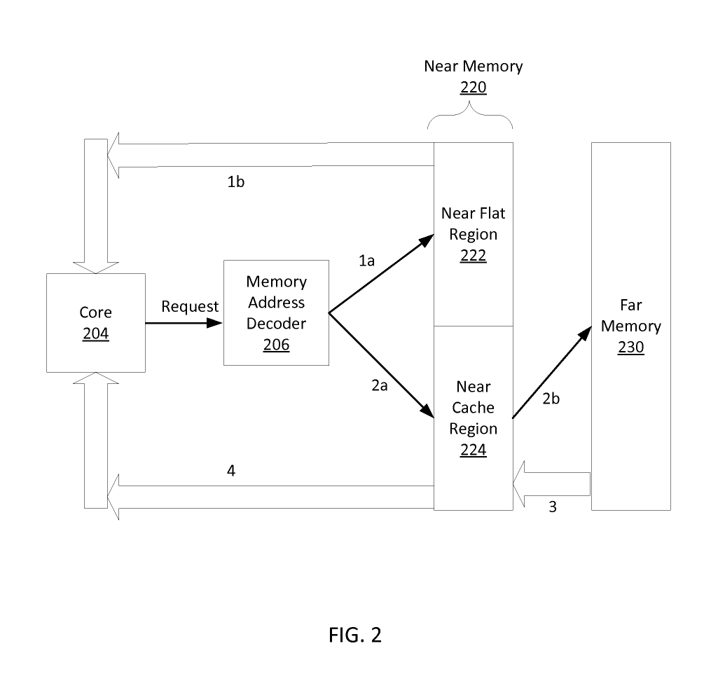

FIG. 2 is a block diagram illustrating a data request flow of FIG. 1 in accordance with an embodiment of the present disclosure. In one embodiment, the core 204 is same as the core 104 described above with respect to FIG. 1. In one embodiment, the near memory 220 is same as the near memory 120 describe above with respect to FIG. 1. In one embodiment, the near flat (NF) region 222 and the near cache (NC) region 224 are the same as the NF region 122 and the NC region 124 respectively with respect to FIG. 1. In one embodiment, the far memory 230 is same as the far memory 130 described above with respect to FIG. 1. Also, in this embodiment, the MC 106 of FIG. 1 is a memory address decoder 206.

In one embodiment, during run time, the core 204 sends a request to the memory address decoder 206. In one embodiment, the run-time means that the OS is booted and the CPU is running an application, which is accessing memory. In one embodiment, the request is to fetch data for the application. In one embodiment, the memory address decoder 206 analyzes the request to determine the destination of the request. In one example, the memory address decoder 206 determines that the request is destined for the NF 222 of the near memory 220. The memory address decoder 206 contains enough information about the system address map, that it knows when an address falls into a region of memory that is tagged as near flat. As such, the memory address decoder 206 contains a set of address rules, then an incoming request includes an address, which falls into one of those mapping rules. That address rules, which govern near flat memory spaces includes information telling it that it needs to be treated differently and access the NF 222 of the near memory 220. These memory address rules (or tables) are set up and programmed as the system is powered-on or reset before the OS comes on-line. The memory address decoder 206 sends the request directly to the NF 222 via path 1a. The NF 222 sends data (high bandwidth) to the core 204 via path 1b for consumption.

In another example, the memory address decoder 206 determines that the request is destined for the NC 224 of the near memory 220. Similarly as the memory table mechanism as described above, those addresses fall into the near cache rules and be treated differently so that they are directed to the portion of the near memory 220, which acts as the NC regions 224.

The memory address decoder 206 sends the request to the NC 224 of the near memory 220 via path 2a. In this example, two scenarios may occur. In one scenario, the NC 224 contains a copy of the data (high bandwidth) requested in the request from the core 204. As such, the NC 224 sends data (high bandwidth) to the core 204 via path 4 for consumption. In another scenario, the NC does not contain a cached copy of the data requested from the core 204. So, the request is forward to the far memory 230 via path 2b. The far memory 230 sends data (low bandwidth) to the NC 224 via path 3 as a cache-fill. The NC 224 sends the data (low bandwidth) to the core 204 via path 4 for consumption. Although not shown, the far memory 230 may send the data (low bandwidth) directly to the core 204.

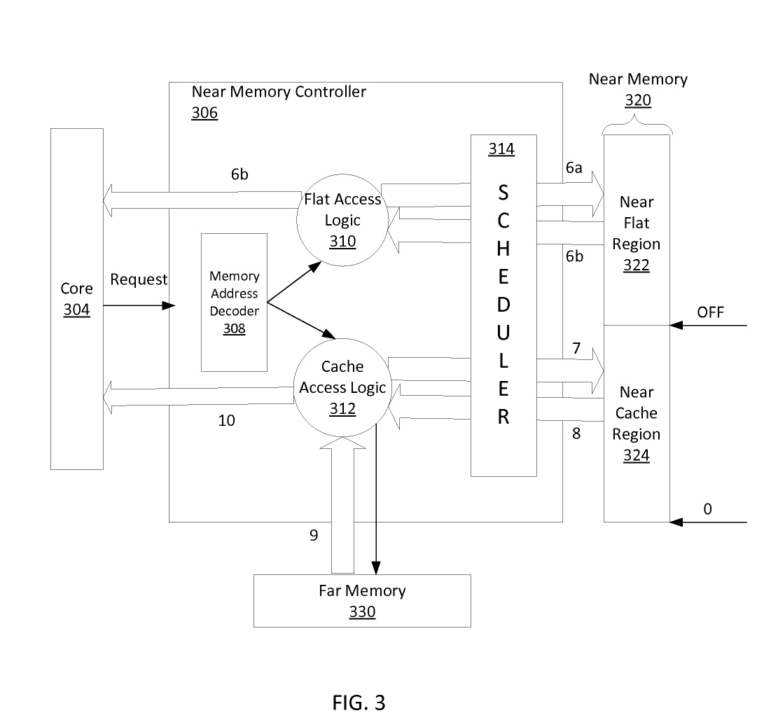

FIG. 3 is a block diagram illustrating a data request flow of FIG. 1 in accordance with another embodiment of the present disclosure. In one embodiment, the core 304 is same as the core 104 described above with respect to FIG. 1. In one embodiment, the near memory 320 is same as the near memory 120 describe above with respect to FIG. 1. In one embodiment, the near flat (NF) region 322 and the near cache (NC) region 324 are the same as the NF region 122 and the NC region 124 respectively with respect to FIG. 1. In one embodiment, the NC region 122 of the near memory 120 is illustrated as starting at address 0. In one embodiment, the NF region 124 of the near memory 120 is illustrated as starting at address OFF and consuming the rest of the near memory 120. In one embodiment, the far memory 330 is same as the far memory 130 described above with respect to FIG. 1. Also, in this embodiment, the MC 106 of FIG. 1 is a near memory controller (NMC) 306.

In one embodiment, during runtime, the core 304 sends a request to the NMC 306. In one embodiment, the request is to fetch data for the application from the near memory 320. The NMC 306 includes a memory address decoder 308, a flat access logic 310, cache access logic 312 and a memory scheduler 314. In one embodiment, the memory address decoder 308 analyzes the request to determine whether the request is a flat memory request or a cache memory request. In one embodiment, the device address of the near memory 320. As discussed above, the memory table mechanism is used to determine whether the request is a flat memory request or a cache memory request. In one example, the memory address decoder 308 determines that the request is a flat memory request and is destined for the NF region 322 of the near memory 320. The memory address decoder 308 adjusts device address of the near memory 320 so that data is derived from the NF region 322 of the near memory 320 As shown, the near memory 320 device is divided into the NF region 322 and the NC region 324. The NC region 324 is at the bottom of the near memory 320 (starting at address ZERO) and the NF region 322 is at the top of near memory 320 320. For example if the near memory 320 device was 2 GB in size and the Hybrid was ¼ mode, the cache portion would be 0-512 MB, and the near-flat would be from 512 MB to 2 GB. So, for NF region 322 accesses, the device address of the near memory 320 is offset (or adjusted) so that it correctly jumps to the NF region 322 and doesn't map into any portion of the NC region 324.

The memory address decoder 308 sends the flat memory request directly to the flat access logic 310. The flat access logic 310 tracks the flat memory request and sends the flat memory request to the memory scheduler 314. After, the memory scheduler 314 receives the flat memory request, the memory scheduler 314 schedules to send the flat memory request to the NF region 322 via path 6a. The NF region 322 then sends data (high bandwidth) to the flat access logic 310, which eventually sends it to the core 304 via path 6b for consumption.

In another example, the memory address decoder 308 determines that the request is a cache memory request and is destined for the NC region 324 of the near memory 320. The memory address decoder 308 adjusts the device address of the near memory 320 so that data is derived from the NC region 324 of the near memory 320. As discussed above, the device address of the near memory 320 is adjusted so, for NC region 324 access, the device address of the near memory 320 is offset (or adjusted) so that it correctly jumps to the NC region 324 and doesn't map into any portion of the NF region 322.

The memory address decoder 308 sends the cache memory request directly to the cache access logic 312. The cache access logic 312 tracks the cache memory request and sends the cache memory request to the memory scheduler 314. The memory scheduler 314 sends the cache memory request to the NC region 324 via path 7.

In this example, two scenarios may occur. In one scenario, the NC region 324 contains a copy of the data (high bandwidth) requested in the cache memory request from the core 304. As such, the NC region 324 sends data (high bandwidth) to the cache access logic 310 via path 8 and cache access logic 312, which eventually sends it to the core 304 via path 8 for consumption. In another scenario, the cache access logic 310 determines that the copy of the data received from the NC region 324 does not contain a cached copy of the data (high bandwidth) requested in the cache memory request. The cache access logic 310 may then fetch the data from the far memory 130 by forwarding the request received by the core 304 to the far memory 330. In one embodiment, the far memory 330 sends data (low bandwidth) to the cache access logic 312 via path 9 as cache-fill data. In one embodiment, the cache access logic 312 sends (pushes) the cache-fill data to the NC region 324 via the path 8. In one embodiment, the cache access logic 312 sends the cache-fill data received from the far memory 330 to the core 304 via path 10 for consumption. Although, not shown, in another embodiment, the far memory 330 may directly send the data (low bandwidth) directly to the core 304 for consumption.

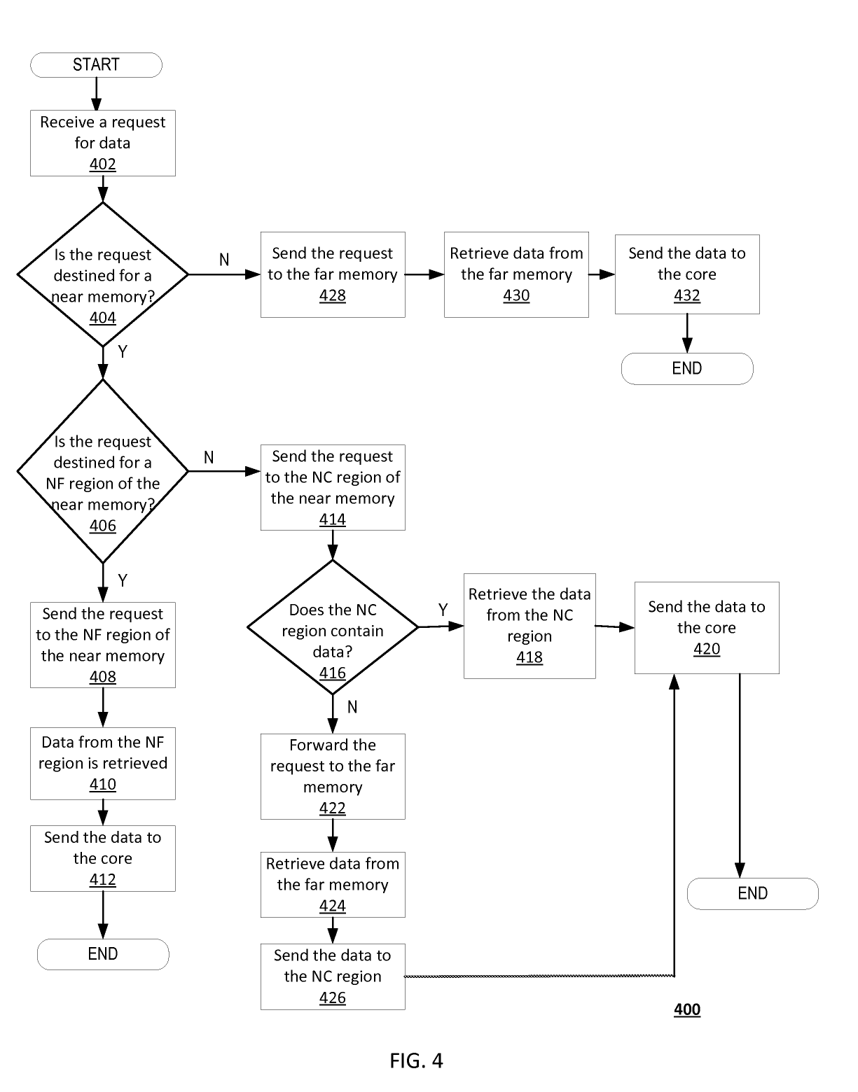

FIG. 4 is a flow diagram of a method 400 for core request flow in a processing device according to an embodiment of the disclosure. Method 400 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 400 may be performed, in part, by the MC 106 and 206 described above with respect to FIGS. 1 and 2.

For simplicity of explanation, method 400 is depicted and described as a series of acts. However, acts in accordance with this disclosure can occur in various orders and/or concurrently and with other acts not presented and described herein. Furthermore, not all illustrated acts may be performed to implement method 400 in accordance with the disclosed subject matter. In addition, those skilled in the art will understand and appreciate that method 400 could alternatively be represented as a series of interrelated states via a state diagram or events.

Method 400 begins at block 402, where processing logic receives a request for data. The processing logic may receive the request from a core. At block 404, the processing logic determines whether the request is destined for near memory. When, at block 404, it is determined that the request is destined for the near memory, then at block 406, it is determined whether the request is destined for a NF region of the near memory. At block 408, the request is sent to the NF region of the near memory when, at block 406, it is determined that the request is destined for the NF region of the near memory. At block 410, the data from the NF region of the near memory retrieved. At block 412, the data is sent to the core.

At block 414, the request is sent to the NC region of the near memory when, at block 406, it is determined that the request is not destined for the NF region of the near memory. At block 416, it is determined whether the NC region of the near memory contains the data. At block 418, the data is retrieved from the NC region when, at block 416, it is determined that the NC region of the near memory contains the data. At block 420, the data is sent to the core.

When, at block 416, it is determined that NC region of the near memory does not contain the data, then, at block 422, the request is forwarded to the far memory. At block 424, the data is retrieved from the far memory. At block 426, the data is sent to the NC region of the near memory. Then method 400 proceeds to block 420 where the data is sent directly from the far memory to the core.

Referring back to block 404, when it is determined that the request is not destined for the near memory, then, at block 428, the request is sent to the far memory. At block 430, the data is retrieved from the far memory. At block 432, the data is sent to the core.

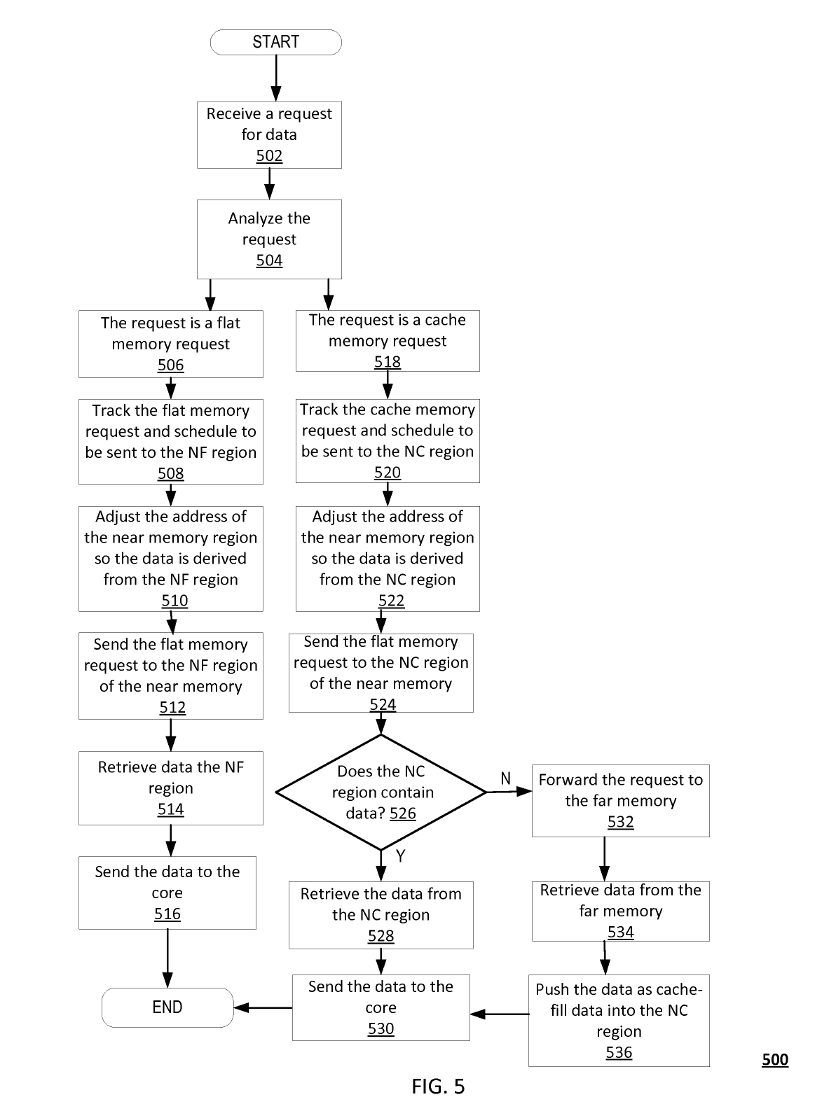

FIG. 5 is a flow diagram of a method 500 for core request flow in a processing device according to an embodiment of the disclosure. Method 500 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 500 may be performed, in part, by MC 106 and NMC 306 described above with respect to FIGS. 1 and 3.

For simplicity of explanation, method 500 is depicted and described as a series of acts. However, acts in accordance with this disclosure can occur in various orders and/or concurrently and with other acts not presented and described herein. Furthermore, not all illustrated acts may be performed to implement method 500 in accordance with the disclosed subject matter. In addition, those skilled in the art will understand and appreciate that method 500 could alternatively be represented as a series of interrelated states via a state diagram or events.

Method 500 begins at block 502 where processing logic receives a request for data. In one embodiment, the request is to fetch data for an application from a near memory. The processing logic may receive the request from a core. At block 504, the processing logic analyzes the request. At block 506, it is determined that the request is a flat memory request. At block 508, the flat memory request is tracked and scheduled to be sent to the NF region of the near memory. At block 510, the address of the near memory is adjusted so that the data is derived from the NF region of the near memory. At block 512, the flat memory request is sent to the NF region of the near memory. At block 514, the data is retrieved from the NF region. At block 516, the data is sent to the core.

At block 518, it is determined that the request is a cache memory request. At block 520, the cache memory request is tracked and scheduled to be sent to the NC region of the near memory. At block 522, the address of the near memory is adjusted so that the data is derived from the NC region of the near memory. At block 524, the cache memory request is sent to the NC region of the near memory. At block 526, it is determined whether the NC region contains the data.

When at block 526, it is determined that the NC region contains the data, then, at block 528, the data is retrieved from the NC region. At block 530, the data is sent to the core. When, at block 528, it is determined that the NC region does not contain the data, then, at block 532, the request is forwarded to the far memory. At block 534, the data is retrieved from the far memory. At block 536, the data is pushed as cache-fill data into the NC region of the near memory. Then method 500 proceeds to block 530 where the data is sent to the core. In one embodiment, the data is sent directly from the far memory to the core.

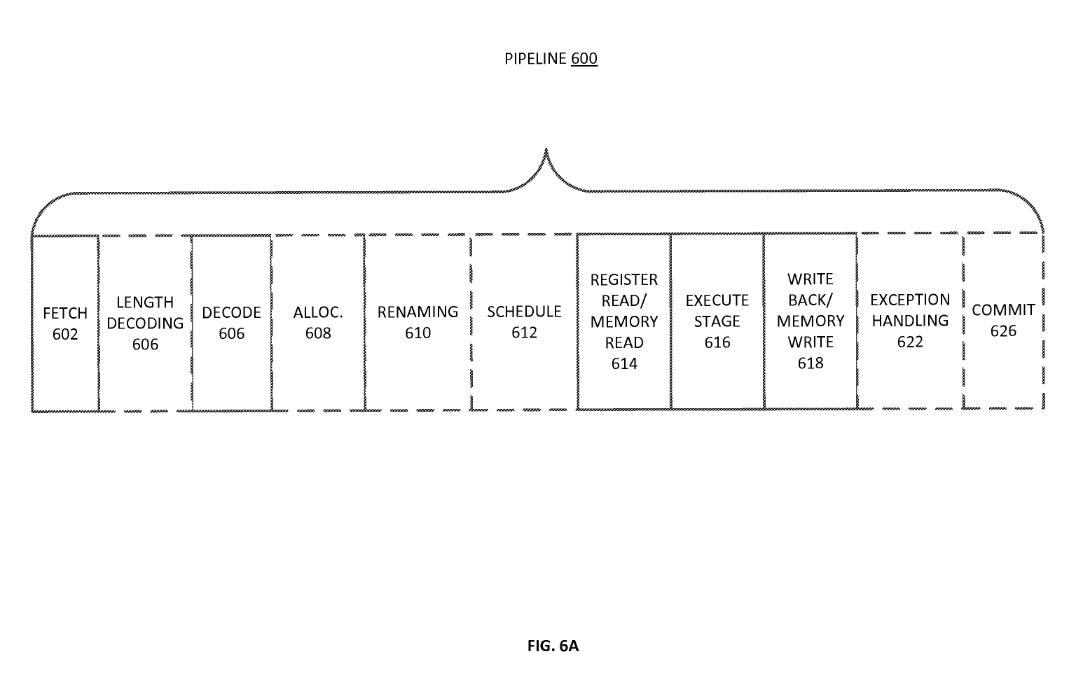

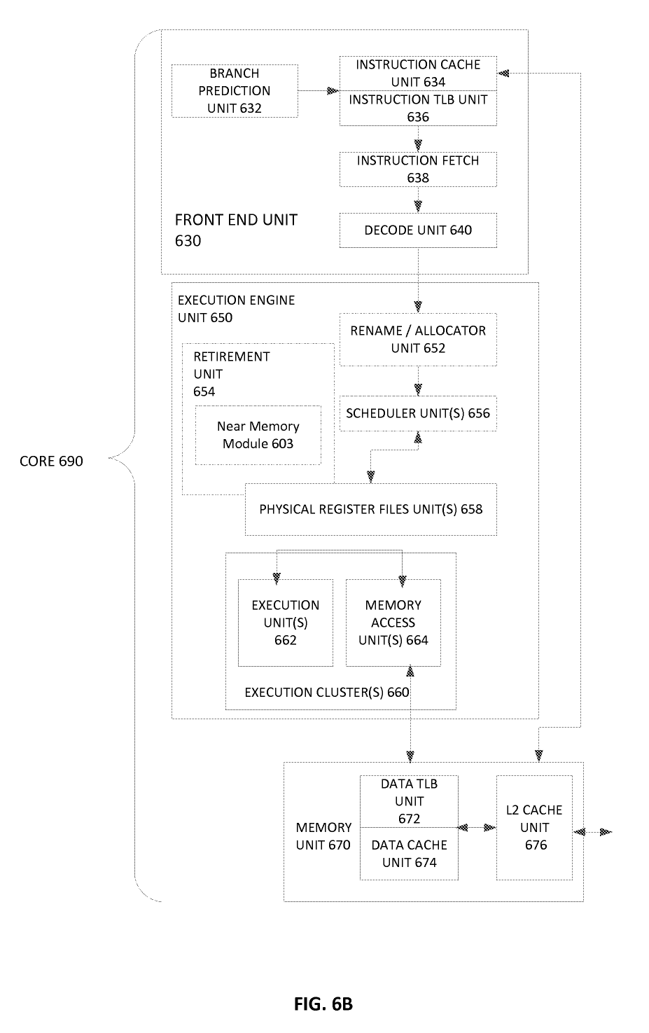

FIG. 6A is a block diagram illustrating an in-order pipeline and a register renaming stage, out-of-order issue/execution pipeline of a processor monitoring performance of a processing device to manage non-precise events according to at least one embodiment of the invention. FIG. 6B is a block diagram illustrating an in-order architecture core and a register renaming logic, out-of-order issue/execution logic to be included in a processor according to at least one embodiment of the invention. The solid lined boxes in FIG. 6A illustrate the in-order pipeline, while the dashed lined boxes illustrates the register renaming, out-of-order issue/execution pipeline. Similarly, the solid lined boxes in FIG. 6B illustrate the in-order architecture logic, while the dashed lined boxes illustrates the register renaming logic and out-of-order issue/execution logic.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624. In some embodiments, the stages are provided in a different order and different stages may be considered in-order and out-of-order.

In FIG. 6B, arrows denote a coupling between two or more units and the direction of the arrow indicates a direction of data flow between those units. FIG. 6B shows processor core 690 including a front end unit 630 coupled to an execution engine unit 650, and both are coupled to a memory unit 70.

The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, graphics core, or the like.

The front end unit 630 includes a branch prediction unit 632 coupled to an instruction cache unit 634, which is coupled to an instruction translation lookaside buffer (TLB) 636, which is coupled to an instruction fetch unit 638, which is coupled to a decode unit 640. The decode unit or decoder may decode instructions, and generate as an output one or more micro-operations, micro-code entry points, microinstructions, other instructions, or other control signals, which are decoded from, or which otherwise reflect, or are derived from, the original instructions. The decoder may be implemented using various different mechanisms. Examples of suitable mechanisms include, but are not limited to, look-up tables, hardware implementations, programmable logic arrays (PLAs), microcode read only memories (ROMs), etc. The instruction cache unit 634 is further coupled to a level 2 (L2) cache unit 676 in the memory unit 670. The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The retirement unit 654 may include a near memory module 603 divided into a flat memory region and a cache memory region according to embodiments of the invention. The scheduler unit(s) 656 represents any number of different schedulers, including reservations stations, central instruction window, etc. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 658 is overlapped by the retirement unit 654 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point).

While some embodiments may include a number of execution units dedicated to specific functions or sets of functions, other embodiments may include one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 38 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 5) the physical register file(s) unit(s) 658 and the memory unit 670 perform the register read/memory read stage 614; the execution cluster 660 perform the execute stage 616; 6) the memory unit 670 and the physical register file(s) unit(s) 658 perform the write back/memory write stage 618; 7) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in-order architecture. While the illustrated embodiment of the processor also includes a separate instruction and data cache units 634/674 and a shared L2 cache unit 676, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

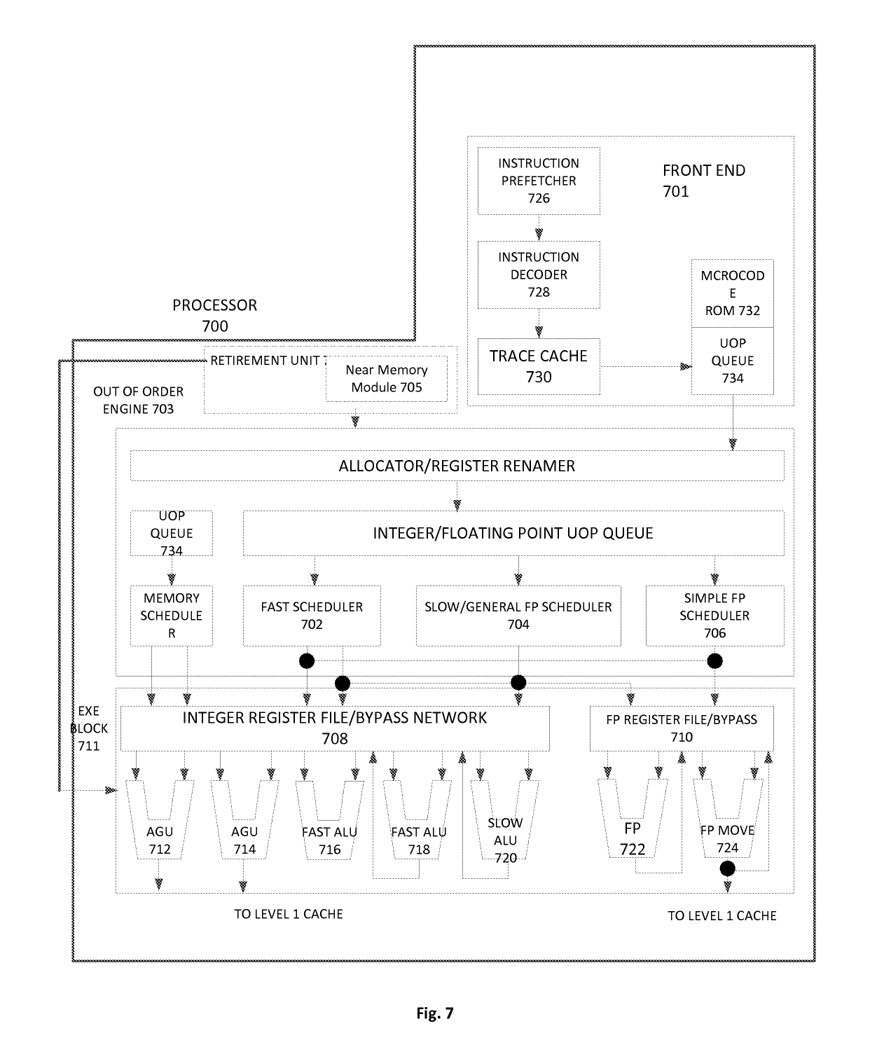

FIG. 7 is a block diagram illustrating a micro-architecture for a processor 700 that includes logic circuits to perform instructions in accordance with one embodiment of the invention. In one embodiment, processor 700 monitors performance of a processing device to manage non-precise events. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 701 is the part of the processor 700 that fetches instructions to be executed and prepares them to be used later in the processor pipeline. The front end 701 may include several units. In one embodiment, the instruction prefetcher 726 fetches instructions from memory and feeds them to an instruction decoder 728, which in turn decodes or interprets them. For example, in one embodiment, the decoder decodes a received instruction into one or more operations called “micro-instructions” or “micro-operations” (also called micro op or uops) that the machine can execute.

In other embodiments, the decoder parses the instruction into an opcode and corresponding data and control fields that are used by the micro-architecture to perform operations in accordance with one embodiment. In one embodiment, the trace cache 730 takes decoded uops and assembles them into program ordered sequences or traces in the uop queue 734 for execution. When the trace cache 730 encounters a complex instruction, the microcode ROM 732 provides the uops needed to complete the operation.

Some instructions are converted into a single micro-op, whereas others use several micro-ops to complete the full operation. In one embodiment, if more than four micro-ops are needed to complete an instruction, the decoder 728 accesses the microcode ROM 732 to do the instruction. For one embodiment, an instruction can be decoded into a small number of micro ops for processing at the instruction decoder 728. In another embodiment, an instruction can be stored within the microcode ROM 732 should a number of micro-ops be needed to accomplish the operation. The trace cache 730 refers to an entry point programmable logic array (PLA) to determine a correct micro-instruction pointer for reading the micro-code sequences to complete one or more instructions in accordance with one embodiment from the micro-code ROM 732. After the microcode ROM 732 finishes sequencing micro-ops for an instruction, the front end 701 of the machine resumes fetching micro-ops from the trace cache 730.

The out-of-order execution engine 703 is where the instructions are prepared for execution. The out-of-order execution logic has a number of buffers to smooth out and reorder the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 702, slow/general floating point scheduler 704, and simple floating point scheduler 706. The uop schedulers 702, 704, 706 determine when a uop is ready to execute based on the readiness of their dependent input register operand sources and the availability of the execution resources the uops use to complete their operation. The fast scheduler 702 of one embodiment can schedule on each half of the main clock cycle while the other schedulers can schedule once per main processor clock cycle. The schedulers arbitrate for the dispatch ports to schedule uops for execution.

Register files 708, 710 sit between the schedulers 702, 704, 706, and the execution units 712, 714, 716, 718, 720, 722, 724 in the execution block 711. There is a separate register file for integer and floating point operations, respectively. Each register file 708, 710, of one embodiment also includes a bypass network that can bypass or forward just completed results that have not yet been written into the register file to new dependent uops. The integer register file 708 and the floating point register file 710 are also capable of communicating data with the other. For one embodiment, the integer register file 708 is split into two separate register files, one register file for the low order 32 bits of data and a second register file for the high order 32 bits of data. The floating point register file 710 of one embodiment has 128 bit wide entries because floating point instructions typically have operands from 66 to 128 bits in width.

The execution block 711 contains the execution units 712, 714, 716, 718, 720, 722, 724, where the instructions are actually executed. This section includes the register files 708, 710, that store the integer and floating point data operand values that the micro-instructions use to execute. The processor 700 of one embodiment is comprised of a number of execution units: address generation unit (AGU) 712, AGU 714, fast ALU 716, fast ALU 718, slow ALU 720, floating point ALU 722, floating point move unit 724. For one embodiment, the floating point execution blocks 722, 724, execute floating point, MMX, SIMD, and SSE, or other operations. The floating point ALU 722 of one embodiment includes a 64 bit by 54 bit floating point divider to execute divide, square root, and remainder micro-ops. For embodiments of the invention, instructions involving a floating point value may be handled with the floating point hardware.

In one embodiment, the ALU operations go to the high-speed ALU execution units 716, 718. The fast ALUs 716, 718, of one embodiment can execute fast operations with an effective latency of half a clock cycle. For one embodiment, most complex integer operations go to the slow ALU 720 as the slow ALU 720 includes integer execution hardware for long latency type of operations, such as a multiplier, shifts, flag logic, and branch processing. Memory load/store operations are executed by the AGUs 712, 714. For one embodiment, the integer ALUs 716, 718, 720 are described in the context of performing integer operations on 64 bit data operands. In alternative embodiments, the ALUs 716, 718, 720 can be implemented to support a variety of data bits including 16, 32, 128, 256, etc. Similarly, the floating point units 722, 724 can be implemented to support a range of operands having bits of various widths. For one embodiment, the floating point units 722, 724 can operate on 128 bits wide packed data operands in conjunction with SIMD and multimedia instructions.

In one embodiment, the uops schedulers 702, 704, 706 dispatch dependent operations before the parent load has finished executing. As uops are speculatively scheduled and executed in processor 700, the processor 700 also includes logic to handle memory misses. If a data load misses in the data cache, there can be dependent operations in flight in the pipeline that have left the scheduler with temporarily incorrect data. A replay mechanism tracks and re-executes instructions that use incorrect data. The dependent operations should be replayed and the independent ones are allowed to complete. The schedulers and replay mechanism of one embodiment of a processor are also designed to catch instruction sequences for text string comparison operations.

The processor 700 may include a retirement unit 754 coupled to the execution block 711. The retirement unit 754 may include a near memory module 705 divided into a flat memory region and a cache memory region according to embodiments of the invention.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data.

A register file of one embodiment also contains eight multimedia SIMD registers for packed data. For the discussions below, the registers are understood to be data registers designed to hold packed data, such as 64 bits wide MMX registers (also referred to as ‘mm’ registers in some instances) in microprocessors enabled with the MMX™ technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not differentiate between the two data types. In one embodiment, integer and floating point are contained in either the same register file or different register files. Furthermore, in one embodiment, floating point and integer data may be stored in different registers or the same registers.

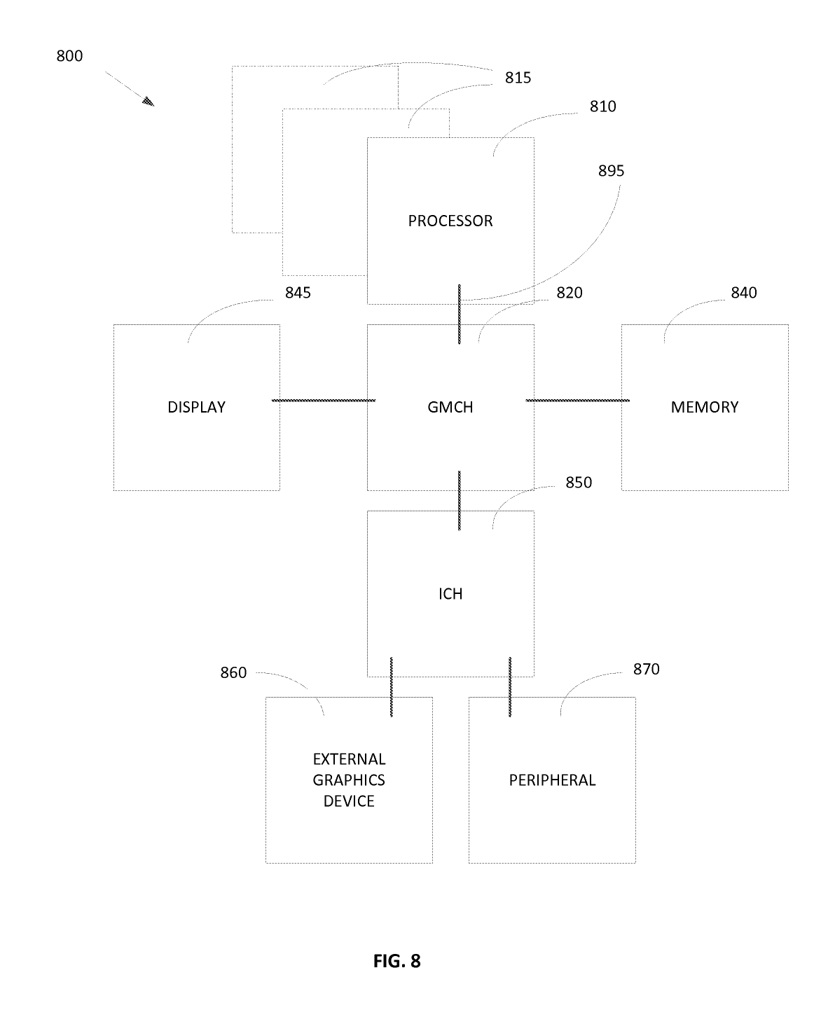

Referring now to FIG. 8, shown is a block diagram of a system 800 in accordance with one embodiment of the invention. The system 800 may include one or more processors 810, 815, which are coupled to graphics memory controller hub (GMCH) 820. The optional nature of additional processors 815 is denoted in FIG. 8 with broken lines. In one embodiment, a processor 810, 815 monitors performance of a processing device to manage non-precise events.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural thermal, power consumption characteristics, and the like. These differences may effectively manifest themselves as asymmetry and heterogeneity amongst the processors 810, 815. For at least one embodiment, the various processors 810, 815 may reside in the same die package.

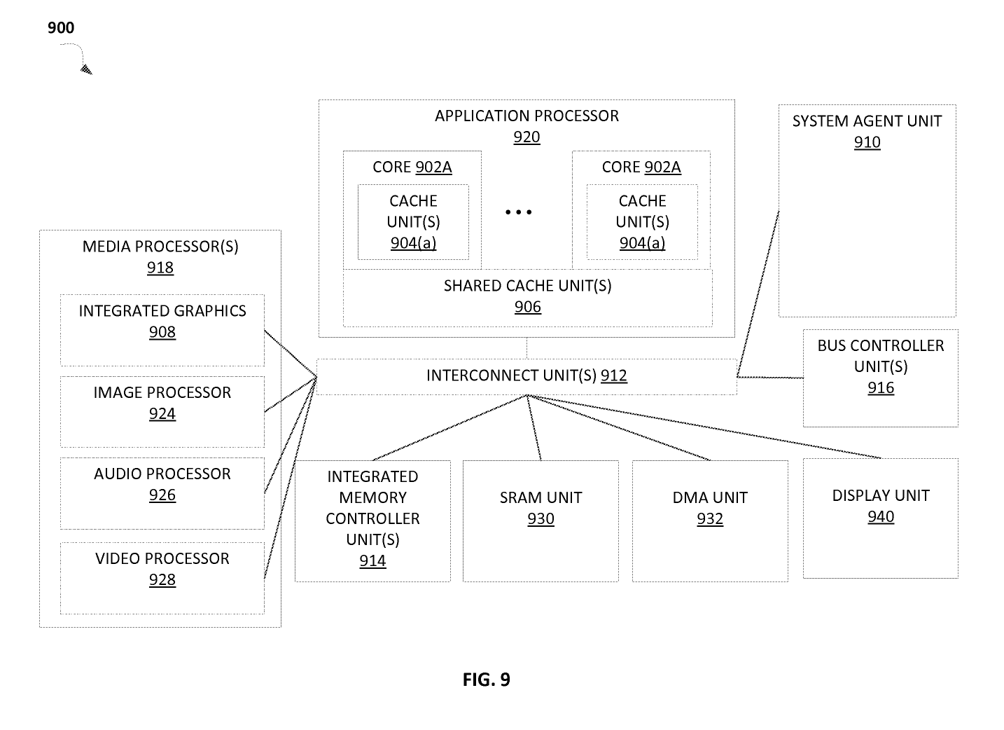

Embodiments may be implemented in many different system types. FIG. 9 is a block diagram of a SoC 900 in accordance with an embodiment of the present disclosure. Dashed lined boxes are optional features on more advanced SoCs. In FIG. 9, an interconnect unit(s) 912 is coupled to: an application processor 920 which includes a set of one or more cores 902A-N and shared cache unit(s) 906; a system agent unit 910; a bus controller unit(s) 916; an integrated memory controller unit(s) 914; a set or one or more media processors 918 which may include integrated graphics logic 908, an image processor 924 for providing still and/or video camera functionality, an audio processor 926 for providing hardware audio acceleration, and a video processor 928 for providing video encode/decode acceleration; an static random access memory (SRAM) unit 930; a direct memory access (DMA) unit 932; and a display unit 940 for coupling to one or more external displays. In one embodiment, a memory module may be included in the integrated memory controller unit(s) 914. In another embodiment, the memory module may be included in one or more other components of the SoC 900 that may be used to access and/or control a memory. The application processor 920 may include a conditional branch, indirect branch and event execution logics as described in embodiments herein.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof.

In some embodiments, one or more of the cores 902A-N are capable of multithreading.

The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture and/or instruction set. For example, some of the cores 902A-N may be in order while others are out-of-order. As another example, two or more of the cores 902A-N may be capable of execution the same instruction set, while others may be capable of executing only a subset of that instruction set or a different instruction set.

The application processor 920 may be a general-purpose processor, such as a Core™ i3, i5, i7, 2 Duo and Quad, Xeon™, Itanium™, Atom™, XScale™ or StrongARM™ processor, which are available from Intel™ Corporation, of Santa Clara, Calif. Alternatively, the application processor 920 may be from another company, such as ARM Holdings™, Ltd, MIPS™, etc. The application processor 920 may be a special-purpose processor, such as, for example, a network or communication processor, compression engine, graphics processor, co-processor, embedded processor, or the like. The application processor 920 may be implemented on one or more chips. The application processor 920 may be a part of and/or may be implemented on one or more substrates using any of a number of process technologies, such as, for example, BiCMOS, CMOS, or NMOS.

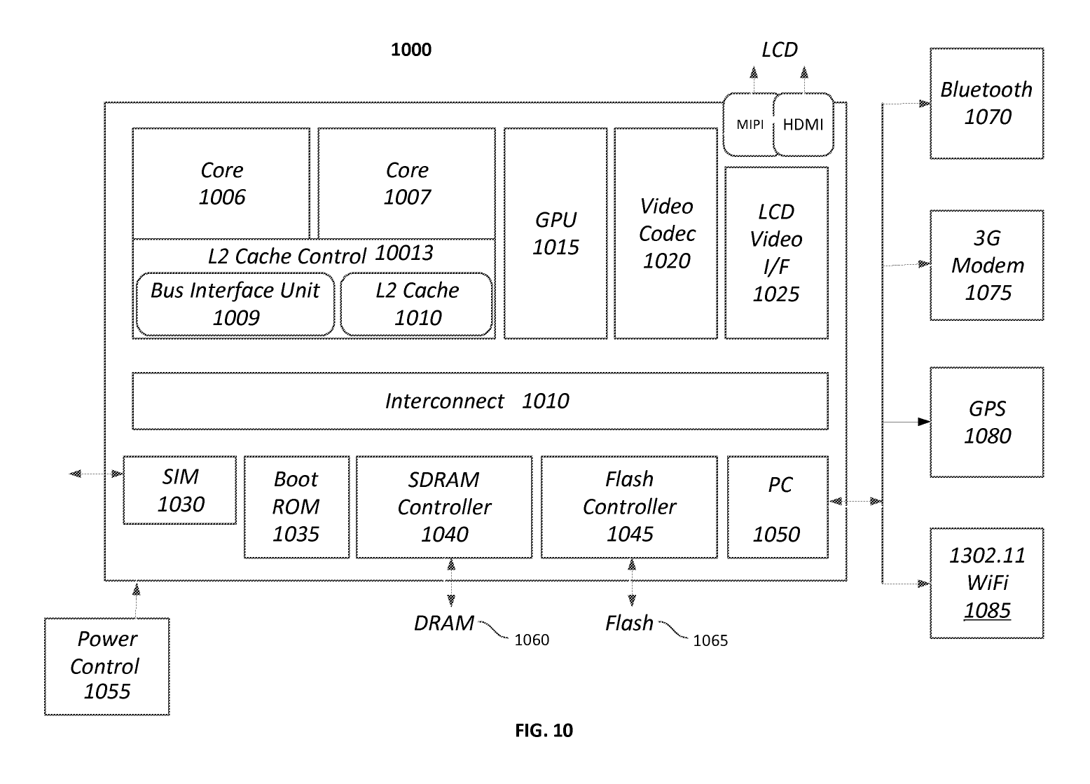

FIG. 10 is a block diagram of an embodiment of a system on-chip (SoC) design in accordance with the present disclosure. As a specific illustrative example, SoC 1000 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1000 includes 2 cores—1006 and 1007. Cores 1006 and 1007 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1006 and 1007 are coupled to cache control 1008 that is associated with bus interface unit 1008 and L2 cache 1010 to communicate with other parts of system 1000. Interconnect 1010 includes an on-chip interconnect, such as an IOSF, AMBA, or other interconnect discussed above, which potentially implements one or more aspects of the described disclosure. In one embodiment, a conditional branch, indirect branch and event execution logics may be included in cores 1006, 1007.

Interconnect 1010 provides communication channels to the other components, such as a Subscriber Identity Module (SIM) 1030 to interface with a SIM card, a boot ROM 1035 to hold boot code for execution by cores 1006 and 1007 to initialize and boot SoC 1000, a SDRAM controller 1040 to interface with external memory (e.g. DRAM 1060), a flash controller 1045 to interface with non-volatile memory (e.g. Flash 1065), a peripheral control 1050 (e.g. Serial Peripheral Interface) to interface with peripherals, video codecs 1020 and Video interface 1025 to display and receive input (e.g. touch enabled input), GPU 1015 to perform graphics related computations, etc. Any of these interfaces may incorporate aspects of the disclosure described herein. In addition, the system 1000 illustrates peripherals for communication, such as a Bluetooth module 1070, 3G modem 1075, GPS 1080, and Wi-Fi 1085.

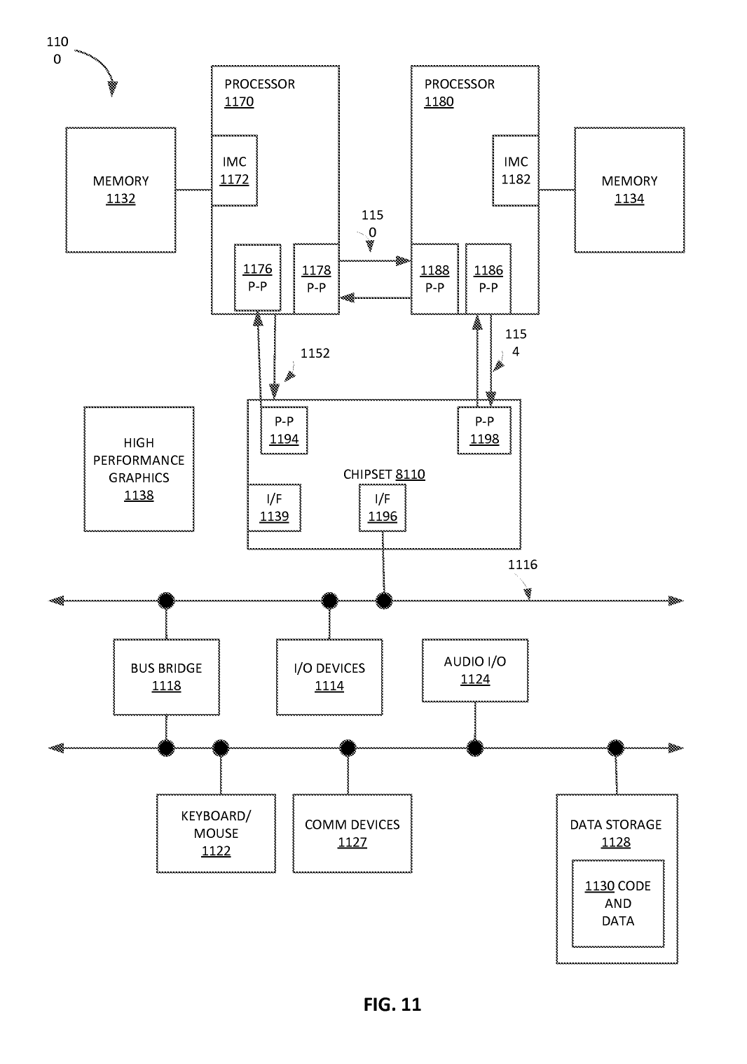

Referring now to FIG. 11, shown is a block diagram of a system 1100 in accordance with an embodiment of the invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processors of the computing systems as described herein. In one embodiment, processors 1170, 1180 monitoring performance of a processing device to manage non-precise events to monitor performance of a processing device to manage non-precise events.

While shown with two processors 1170, 1180, it is to be understood that the scope of the disclosure is not so limited. In other embodiments, one or more additional processors may be present in a given processor.

Processors 1170 and 1180 are shown including integrated memory controller units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170 and 1180 may each exchange information with a chipset 1190 via individual P-P interfaces 1152, 1154 using point to point interface circuits 1176, 1194, 1186, 1198. Chipset 1190 may also exchange information with a high-performance graphics circuit 1138 via a high-performance graphics interface 1139.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1116. In one embodiment, first bus 1116 may be a Peripheral Component Interconnect (PCI) bus, or a bus such as a PCI Express bus or another third generation I/O interconnect bus, although the scope of the disclosure is not so limited.

As shown in FIG. 11, various I/O devices 1114 may be coupled to first bus 1116, along with a bus bridge 1118, which couples first bus 1116 to a second bus 1120. In one embodiment, second bus 1120 may be a low pin count (LPC) bus. Various devices may be coupled to second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to second bus 1120. Note that other architectures are possible. For example, instead of the point-to-point architecture of FIG. 11, a system may implement a multi-drop bus or other such architecture.

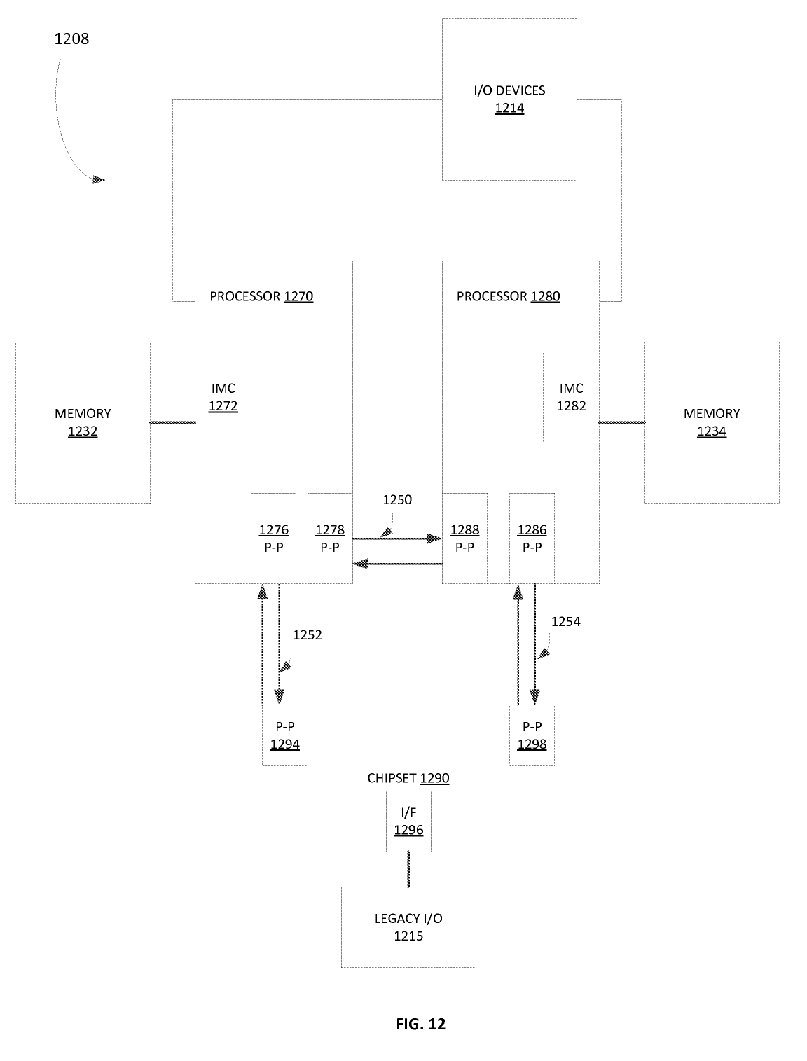

Referring now to FIG. 12, shown is a block diagram of a system 1200 in accordance with an embodiment of the invention. FIG. 12 illustrates processors 1270, 1280. In one embodiment, processors 1270, 1280 monitor performance of a processing device to manage non-precise events. Furthermore, processors 1270, 1280 may include integrated memory and I/O control logic (“CL”) 1272 and 1282, respectively and intercommunicate with each other via point-to-point interconnect 1250 between point-to-point (P-P) interfaces 1278 and 1288 respectively. Processors 1270, 1280 each communicate with chipset 1290 via point-to-point interconnect 1252 and 1254 through the respective P-P interfaces 1276 to 1294 and 1286 to 1298 as shown. For at least one embodiment, the CL 1272, 1282 may include integrated memory controller units. CLs 1272, 1282 may include I/O control logic. As depicted, memories 1232, 1234 coupled to CLs 1272, 1282 and I/O devices 1214 are also coupled to the control logic 1272, 1282. Legacy I/O devices 1215 are coupled to the chipset 1290 via interface 1296.

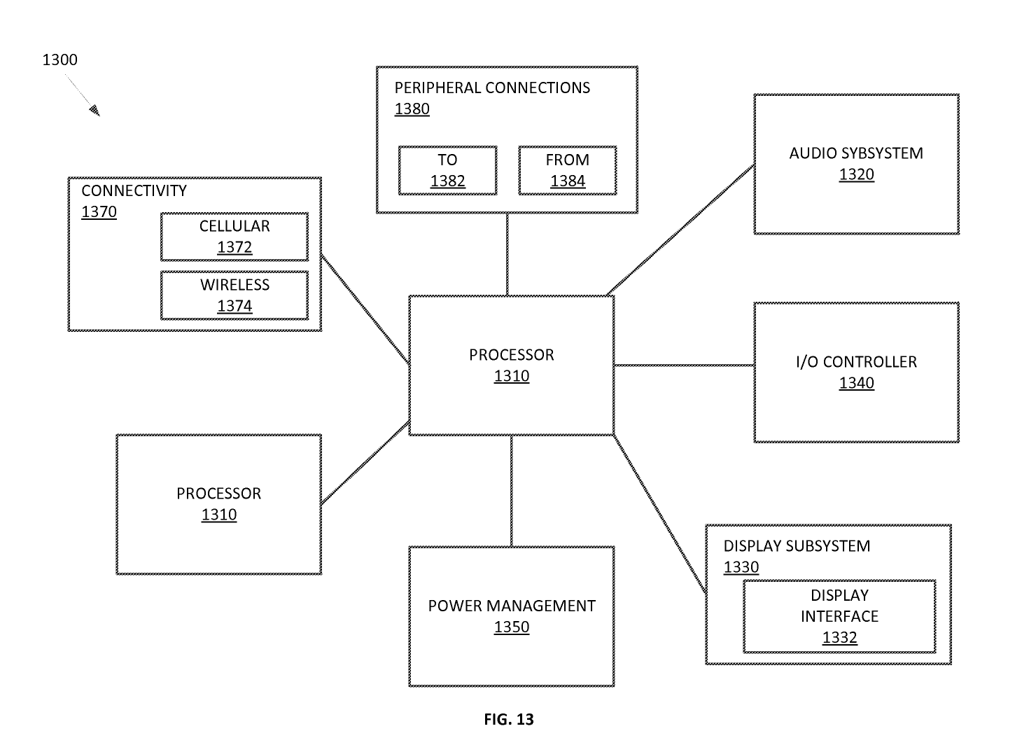

FIG. 13 illustrates a block diagram 1300 of an embodiment of tablet computing device, a smartphone, or other mobile device in which touchscreen interface connectors may be used. Processor 1310 may monitor performance of a processing device to manage non-precise events. In addition, processor 1310 performs the primary processing operations. Audio subsystem 1320 represents hardware (e.g., audio hardware and audio circuits) and software (e.g., drivers, codecs) components associated with providing audio functions to the computing device. In one embodiment, a user interacts with the tablet computing device or smartphone by providing audio commands that are received and processed by processor 1310.

Display subsystem 1332 represents hardware (e.g., display devices) and software (e.g., drivers) components that provide a visual and/or tactile display for a user to interact with the tablet computing device or smartphone. Display subsystem 1330 includes display interface 1332, which includes the particular screen or hardware device used to provide a display to a user. In one embodiment, display subsystem 1330 includes a touchscreen device that provides both output and input to a user.

I/O controller 1340 represents hardware devices and software components related to interaction with a user. I/O controller 1340 can operate to manage hardware that is part of audio subsystem 1320 and/or display subsystem 1330. Additionally, I/O controller 1340 illustrates a connection point for additional devices that connect to the tablet computing device or smartphone through which a user might interact. In one embodiment, I/O controller 1340 manages devices such as accelerometers, cameras, light sensors or other environmental sensors, or other hardware that can be included in the tablet computing device or smartphone. The input can be part of direct user interaction, as well as providing environmental input to the tablet computing device or smartphone.

In one embodiment, the tablet computing device or smartphone includes power management 1350 that manages battery power usage, charging of the battery, and features related to power saving operation. Memory subsystem 1360 includes memory devices for storing information in the tablet computing device or smartphone. Connectivity 1370 includes hardware devices (e.g., wireless and/or wired connectors and communication hardware) and software components (e.g., drivers, protocol stacks) to the tablet computing device or smartphone to communicate with external devices. Cellular connectivity 1372 may include, for example, wireless carriers such as GSM (global system for mobile communications), CDMA (code division multiple access), TDM (time division multiplexing), or other cellular service standards). Wireless connectivity 1374 may include, for example, activity that is not cellular, such as personal area networks (e.g., Bluetooth), local area networks (e.g., WiFi), and/or wide area networks (e.g., WiMax), or other wireless communication.

Peripheral connections 1380 include hardware interfaces and connectors, as well as software components (e.g., drivers, protocol stacks) to make peripheral connections as a peripheral device (“to” 1382) to other computing devices, as well as have peripheral devices (“from” 1384) connected to the tablet computing device or smartphone, including, for example, a “docking” connector to connect with other computing devices. Peripheral connections 1380 include common or standards-based connectors, such as a Universal Serial Bus (USB) connector, DisplayPort including MiniDisplayPort (MDP), High Definition Multimedia Interface (HDMI), Firewire, etc.

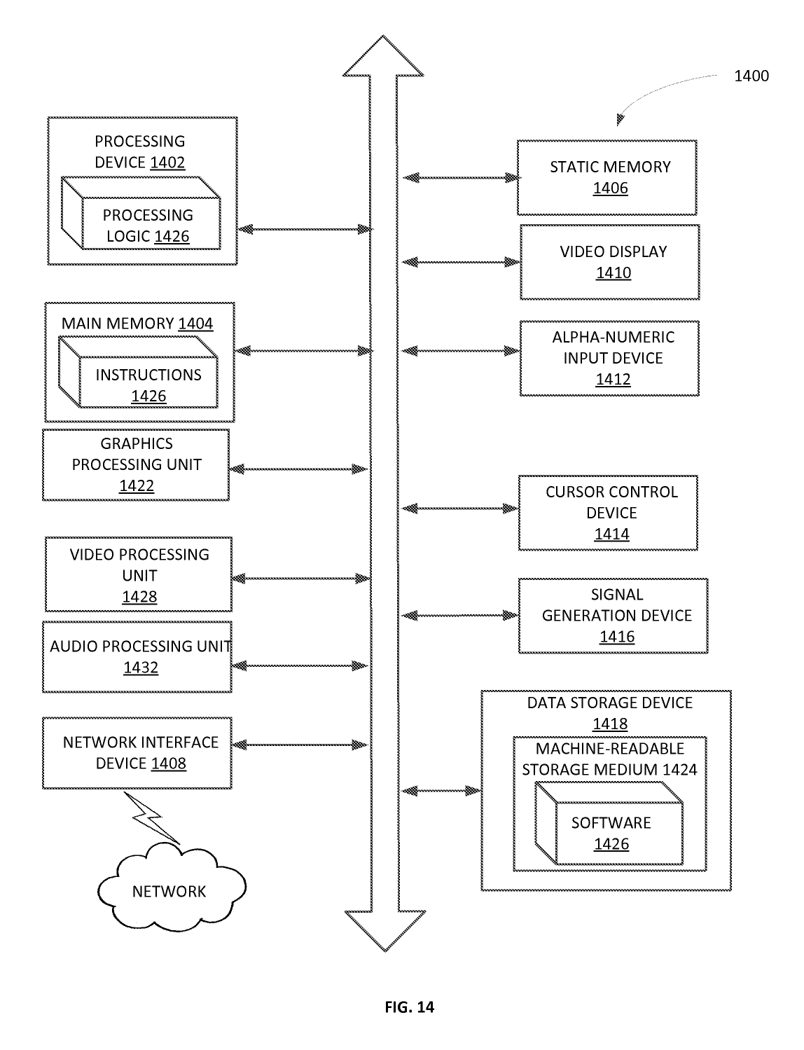

FIG. 14 illustrates a diagrammatic representation of a machine in the example form of a computing system 1400 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computing system 1400 includes a processing device 1402, a main memory 1404 (e.g., read-only memory (ROM), flash memory, dynamic random access memory (DRAM) (such as synchronous DRAM (SDRAM) or DRAM (RDRAM), etc.), a static memory 1406 (e.g., flash memory, static random access memory (SRAM), etc.), and a data storage device 1418, which communicate with each other via a bus 1430.

Processing device 1402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. In one embodiment, processing device 1402 may include one or processing cores. The processing device 1402 is configured to execute the processing logic 1426 for performing the operations discussed herein. In one embodiment, processing device 1402 is the same as computer systems 100 and 200 as described with respect to FIG. 1 that implements the NPEBS module 106. Alternatively, the computing system 1400 can include other components as described herein.

The computing system 1400 may further include a network interface device 1408 communicably coupled to a network 1420. The computing system 1400 also may include a video display unit 1410 (e.g., a liquid crystal display (LCD) or a cathode ray tube (CRT)), an alphanumeric input device 1412 (e.g., a keyboard), a cursor control device 1414 (e.g., a mouse), a signal generation device 1416 (e.g., a speaker), or other peripheral devices. Furthermore, computing system 1400 may include a graphics processing unit 1422, a video processing unit 1428 and an audio processing unit 1432. In another embodiment, the computing system 1400 may include a chipset (not illustrated), which refers to a group of integrated circuits, or chips, that are designed to work with the processing device 1402 and controls communications between the processing device 1402 and external devices. For example, the chipset may be a set of chips on a motherboard that links the processing device 1402 to very high-speed devices, such as main memory 1404 and graphic controllers, as well as linking the processing device 1402 to lower-speed peripheral buses of peripherals, such as USB, PCI or ISA buses.

The data storage device 1418 may include a computer-readable storage medium 1424 on which is stored software 1426 embodying any one or more of the methodologies of functions described herein. The software 1426 may also reside, completely or at least partially, within the main memory 1404 as instructions 1426 and/or within the processing device 1402 as processing logic 1426 during execution thereof by the computing system 1400; the main memory 1404 and the processing device 1402 also constituting computer-readable storage media.

The computer-readable storage medium 1424 may also be used to store instructions 1426 utilizing the NPEBS module 106 described with respect to FIG. 1 and/or a software library containing methods that call the above applications. While the computer-readable storage medium 1424 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the embodiments. The term “computer-readable storage medium” shall accordingly be taken to include, but not be limited to, solid-state memories, and optical and magnetic media. While the invention has been described with respect to a limited number of embodiments, those skilled in the art will appreciate numerous modifications and variations therefrom. It is intended that the appended claims cover all such modifications and variations as fall within the true spirit and scope of this invention.

The following examples pertain to further embodiments.

Example 1 is a processing device comprising a core and a memory controller communicably coupled to the core to receive a request to fetch data, wherein the memory controller is communicably coupled to a hybrid memory architecture comprising a near memory, wherein the near memory is divided into a flat memory region and a cache memory region.

In Example 2, the subject matter of Example 1 can optionally include wherein the flat memory region is configured to a first size and the cache memory region is configured to a second size, wherein the first size is different from the second size.

In Example 3, the subject matter of any one of Examples 1-2 can optionally include wherein the flat memory region is configured to a first size and the cache memory region is configured to a second size, wherein the first size is same as the second size.

In Example 4, the subject matter of any one of Examples 1-3 can optionally include wherein the memory controller to analyze the request to determine whether the request is destined for one of the flat memory region or the cache memory region.

In Example 5, the subject matter of any one of Examples 1-4 can optionally include wherein the analyze comprises map an address in the request with a device address map of the near memory.

In Example 6, the subject matter of any one of Examples 1-5 can optionally include wherein the memory controller to adjust a device address of the near memory when it is determined that the request is destined for one of the flat memory region or the cache memory region.

In Example 7, the subject matter of any one of Examples 1-6 can optionally include wherein the hybrid memory architecture further comprises a far memory.

In Example 8, the subject matter of any one of Examples 1-7 can optionally include wherein the cache memory region forwards the request to the far memory when the data is not available in the cache memory region.

Example 9 is a system comprising a processing device and a hybrid memory architecture communicably coupled to the processing device, wherein the hybrid memory architecture comprising a near memory divided into a flat memory region and a cache memory region.

In Example 10, the subject matter of Example 9 can optionally include wherein the flat memory region is configured to a first size and the cache memory region is configured to a second size, wherein the first size is one of same as the first size or different from the second size.

Example 11 is a method comprising providing to a software, a hybrid memory architecture comprising a near memory, wherein the near memory is divided into a flat memory region and a cache memory region.

In Example 12, the subject matter of Example 11 can optionally include wherein the flat memory region is configured to a first size and the cache memory region is configured to a second size, wherein the first size is one of same as the second size or different from the second size.

In Example 13, the subject matter of any one of Examples 11-12 can optionally include receiving, from the software, a request to fetch data and analyzing the request to determine whether the request is destined for one of the flat memory region or the cache memory region.

In Example 14, the subject matter of any one of Examples 11-13 wherein the hybrid memory architecture further comprises a far memory.

In Example 15, the subject matter of any one of Examples 11-14 can optionally include forwarding the request to a far memory of the hybrid memory architecture when the data is not available in the cache memory region.

Example 16 is a non-transitory machine-readable storage medium including data that, when accessed by a processing device, cause the processing device to perform operations comprising providing to a software, a hybrid memory architecture comprising a near memory, wherein the near memory is divided into a flat memory region and a cache memory region.

In Example 17, the subject matter of Example 16 can optionally include wherein the flat memory region is configured to a first size and the cache memory region is configured to a second size, wherein the first size is one of same as the second size or different from the second size.

In Example 18, the subject matter of any one of Examples 16-17 can optionally include wherein operations further comprising receiving a request to fetch data from the software, analyzing the request to determine whether the request is destined for one of the flat memory region or the cache memory region.

In Example 19, the subject matter of any one of Examples 16-18 can optionally include wherein the hybrid memory architecture further comprises a far memory.

In Example 20, the subject matter of any one of Examples 16-19 can optionally include wherein operations further comprising forwarding the request to a far memory of the hybrid memory architecture when the data is not available in the cache memory region.

Various embodiments may have different combinations of the structural features described above. For instance, all optional features of the SOC described above may also be implemented with respect to a processor described herein and specifics in the examples may be used anywhere in one or more embodiments.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processing device comprising:
a core; and
a memory controller communicably coupled to the core to receive a request to fetch data, wherein the memory controller is communicably coupled to a hybrid memory architecture comprising a near memory, wherein the near memory is divided into a flat memory region and a cache memory region.

2. The processing device of claim 1, wherein the flat memory region is configured to a first size and the cache memory region is configured to a second size, wherein the first size is different from the second size.

3. The processing device of claim 1, wherein the flat memory region is configured to a first size and the cache memory region is configured to a second size, wherein the first size is same as the second size.

4. The processing device of claim 1 wherein the memory controller to analyze the request to determine whether the request is destined for one of the flat memory region or the cache memory region.

5. The processing device of claim 4 wherein the analyze comprises map an address in the request with a device address map of the near memory.

6. The processing device of claim 4 wherein the memory controller to adjust a device address of the near memory when it is determined that the request is destined for the flat memory region.

7. The processing device of claim 6 wherein the hybrid memory architecture further comprises a far memory.

8. The processing device of claim 7, wherein the cache memory region forwards the request to the far memory when the data is not available in the cache memory region.

9. A system comprising:
a processing device; and
a hybrid memory architecture communicably coupled to the processing device, the hybrid memory architecture comprising a near memory divided into a flat memory region and a cache memory region.

10. The system of claim 9, wherein the flat memory region is configured to a first size and the cache memory region is configured to a second size, wherein the first size is one of same as the first size or different from the second size.

11. A method comprising:
providing to a software, a hybrid memory architecture comprising a near memory, wherein the near memory is divided into a flat memory region and a cache memory region.

12. The method of claim 11, wherein the flat memory region is configured to a first size and the cache memory region is configured to a second size, wherein the first size is one of same as the second size or different from the second size.

13. The method of claim 11, further comprising receiving, from the software, a request to fetch data and analyzing the request to determine whether the request is destined for one of the flat memory region or the cache memory region.

14. The method of claim 13, wherein the hybrid memory architecture further comprises a far memory.

15. The method of claim 14 further comprising forwarding the request to a far memory of the hybrid memory architecture when the data is not available in the cache memory region.

16. A non-transitory machine-readable storage medium including instructions that, when accessed by a processing device, cause the processing device to perform operations comprising:
providing to a software, a hybrid memory architecture comprising a near memory, wherein the near memory is divided into a flat memory region and a cache memory region.

17. The non-transitory machine-readable storage medium of claim 16, wherein the flat memory region is configured to a first size and the cache memory region is configured to a second size, wherein the first size is one of same as the second size or different from the second size.

18. The non-transitory machine-readable storage medium of claim 16, wherein the operations further comprising receiving a request to fetch data from the software, analyzing the request to determine whether the request is destined for one of the flat memory region or the cache memory region.

19. The non-transitory machine-readable storage medium of claim 18, wherein the hybrid memory architecture further comprises a far memory.

20. The non-transitory machine-readable storage medium of claim 19, wherein the operations further comprising forwarding the request to a far memory of the hybrid memory architecture when the data is not available in the cache memory region.
